(19) United States
(12) Patent Application Publication
(10) Pub. No.: US 2023/0079835 A1
(43) Pub. Date: Mar. 16, 2023

(54) INFORMATION PROCESSING DEVICE

(71) Applicants: Sony Interactive Entertainment Inc., Tokyo (JP); Sony Interactive Entertainment LLC, San Mateo, CA (US); Sony Group Corporation, Tokyo (JP)

(72) Inventors: Yasushi OKUMURA, Tokyo (JP); Daisuke KAWAMURA, San Mateo, CA (US); Udupi Ramanath BHAT, San Mateo, CA (US); Naoki OGISHITA, San Mateo, CA (US); Goro TAKAKI, Tokyo (JP); Shusuke ESHITA, Tokyo (JP); Matthew FORREST, Tokyo (JP)

(73) Assignees: Sony Interactive Entertainment Inc., Tokyo (JP); Sony Interactive Entertainment LLC, San Mateo, CA (US); Sony Group Corporation, Tokyo, CA (JP)

(21) Appl. No.: 17/943,283

(22) Filed: Sep. 13, 2022

Related U.S. Application Data
(60) Provisional application No. 63/243,780, filed on Sep. 14, 2021.

(51) Int. Cl. H04N 5/222; G06T 7/70; G06T 7/60

(52) U.S. Cl. CPC H04N 5/2228; G06T 7/70; G06T 7/60; G06T 2207/30196; G06T 2207/10012

(57) ABSTRACT

An information processing device includes an obtaining section configured to obtain position information of a plurality of parts of a photographing target, a deriving section configured to derive a length between two parts, and a production control section configured to perform production on the basis of the derived length.

### CROSS REFERENCE TO RELATED APPLICATION

This application claims the benefit of U.S. Patent Application No. 63/243,780 filed Sep. 14, 2021, the entire contents of which are incorporated herein by reference.

### BACKGROUND

The present disclosure relates to a technology for performing production according to movement of a target photographed by a camera.

Recently, a library for estimating the posture of a human has been disclosed as an open source. This library detects characteristic points such as joint positions of a human from a two-dimensional image by using a neural network in which deep learning is performed, and estimates the posture of the human by connecting the characteristic points to each other. Japanese Patent Laid-Open No. 2020-204890 discloses a robot system that estimates the posture of a human photographed by using such a posture estimating model and synchronizes the posture of a robot device with the estimated posture of the user.

### SUMMARY

In a live venue or a concert hall, production is performed which changes lighting and changes the volume of sound according to movement of a performer. Such production has been performed manually. A person in charge of production determines start timing and end timing of production, and manually controls lighting apparatuses and sound apparatuses. During performance by the performer, the person in charge of production observes movement of the performer, and performs work of synchronizing production with the movement of the performer. However, a burden of the work is heavy.

It is desirable to provide a technology that automatically performs production according to movement of a target such as a performer.

According to an aspect of the present technology, there is provided an information processing device including an obtaining section configured to obtain position information of a plurality of parts of a photographing target, a deriving section configured to derive a length between two parts, and a production control section configured to perform production on the basis of the derived length.

According to another aspect of the present technology, there is provided an information processing device including an obtaining section configured to obtain position information of a plurality of parts of a photographing target, a deriving section configured to derive a direction connecting two parts to each other, and a production control section configured to perform production on the basis of the derived direction.

It is to be noted that optional combinations of the above constituent elements and modes obtained by converting expressions of the present technology between a method, a device, a system, a recording medium, a computer program, and the like are also effective as modes of the present technology.

### BRIEF DESCRIPTION OF THE DRAWINGS

FIG. 1 is a diagram illustrating an example of a production system that performs production according to movement of a performer;

FIG. 2 is a diagram illustrating a configuration of an information processing device according to an embodiment;

FIG. 3 is a diagram illustrating an example of a result of estimating the positions of a plurality of parts of the performer;

FIG. 4 is a diagram illustrating a concrete example of the plurality of parts of the performer;

FIG. 5 is a diagram illustrating an example of a derived length between two parts;

FIG. 6 is a diagram illustrating another example of the derived length between the two parts;

FIG. 7 is a diagram illustrating an example of a derived direction connecting two parts to each other;

FIG. 8 is a diagram illustrating an example of video generated by a production control section; and

FIG. 9 is a diagram illustrating an example of video in which the production control section performs video production.

### DETAILED DESCRIPTION OF THE PREFERRED EMBODIMENT

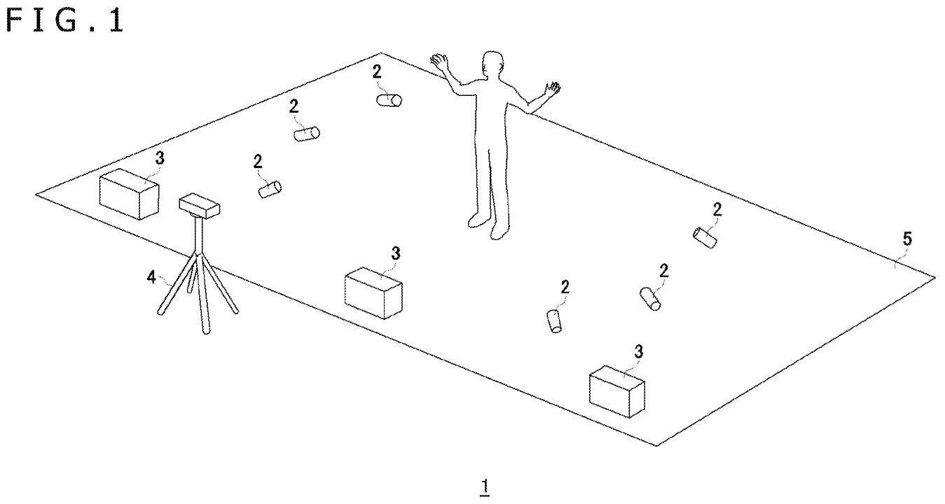

FIG. 1 illustrates an example of a production system 1 that performs production according to the movement of a performer. A stage 5 is provided with a plurality of lighting apparatuses 2 for performing light production and a plurality of sound apparatuses 3 for performing sound production. The production system 1 may be used in a venue in which the performer performs in front of an audience, the venue being a concert hall, an outdoor stage, or the like. While FIG. 1 illustrates a state in which production apparatuses including the lighting apparatuses 2 and the sound apparatuses 3 are provided to the stage 5, these production apparatuses may be provided in the vicinity of the stage 5. It suffices for the production apparatuses to be arranged at such positions as to be able to provide light production and/or sound production to the performer and the audience in the vicinity of the stage 5.

A camera 4 photographs the performer during performance on the stage 5 in predetermined cycles. The camera 4 is a three-dimensional camera capable of obtaining depth information. The camera 4 may be a stereo camera or a time of flight (ToF) camera. The camera 4 photographs a three-dimensional space in which the performer is present in predetermined cycles (for example, 30 frames/sec).

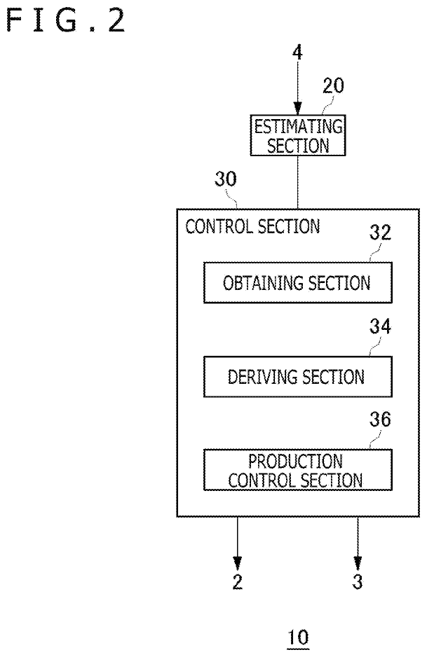

The lighting apparatuses 2 each include a movable unit that can change an irradiation direction of light. The color and light amount of the irradiation light are dynamically changed by an information processing device (see FIG. 2) to be described later. The sound apparatuses 3 each include a movable unit that can change an output direction of sound. A volume and an effect of the output sound are dynamically changed by the information processing device. In the production system 1, the information processing device is provided with an image of the photographed performer from the camera 4, and controls light production by the lighting apparatuses 2 and/or sound production by the sound apparatuses 3 on the basis of the image. The information processing device thereby enlivens the live performance.

FIG. 2 illustrates a configuration of an information processing device 10 according to an embodiment. The information processing device 10 includes an estimating section 20 that estimates the posture and/or position of the performer and a control section 30 that controls production. The control section 30 includes an obtaining section 32, a deriving section 34, and a production control section 36. During the performance by the performer, the control section 30 outputs music from the sound apparatuses 3.

The elements described as functional blocks performing various processes in FIG. 2 can each include a circuit block, a memory, or another large-scale integrated (LSI) circuit or central processing unit (CPU) in terms of hardware, and are implemented by a program loaded in a memory or the like in terms of software. Hence, it is to be understood by those skilled in the art that these functional blocks can be implemented in various forms by only hardware, only software, or combinations of hardware and software, and are not limited to one of the forms. In the information processing device 10, the estimating section 20 and the control section 30 may be implemented by the same processor and may be implemented by separate processors.

The estimating section 20 receives the image of the performer as a photographing target photographed by the camera 4, and estimates the positions of a plurality of parts of a body of the performer. Various methods for recognizing the positions of parts of a human body have been proposed. The estimating section 20 may estimate the position of each part of the performer by using an existing posture estimating technology.

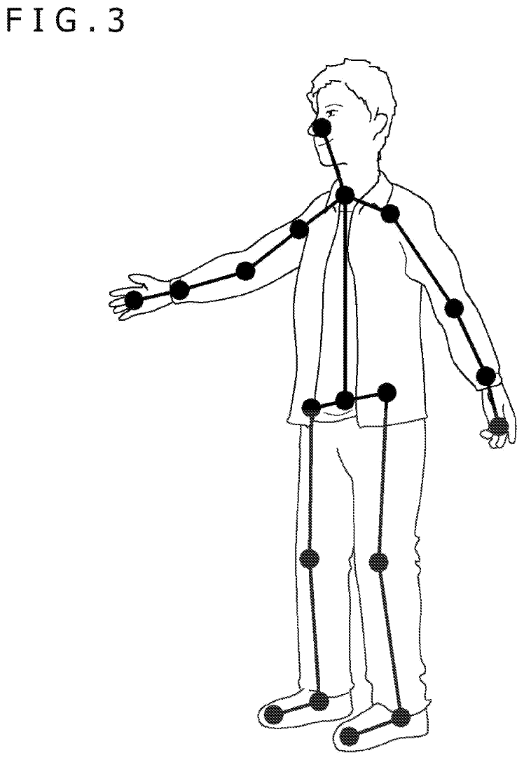

FIG. 3 illustrates an example of a result of estimating the positions of the plurality of parts of the performer. The estimating section 20 estimates the positions of the plurality of parts of the performer in the three-dimensional space, and provides the positions of the plurality of parts of the performer to the control section 30. The estimating section 20 can estimate the posture and position of the performer in the three-dimensional space by estimating the positions of the plurality of parts of the performer in the three-dimensional space and coupling two adjacent parts to each other by a straight line (bone). The estimating section 20 performs posture estimation processing in real time, that is, performs the posture estimation processing in the same cycles as photographing cycles of the camera 4, and provides an estimation result to the control section 30. In the control section 30, the obtaining section 32 obtains position information of the plurality of parts of the body of the performer as a photographing target in predetermined cycles.

In the embodiment, the performer may be a dancer dancing to music, and the posture and position of the performer on the stage 5 change with the passage of time. The production control section 36 performs light production and/or sound production by controlling the lighting apparatuses 2 and/or the sound apparatuses 3 according to movement of the performer.

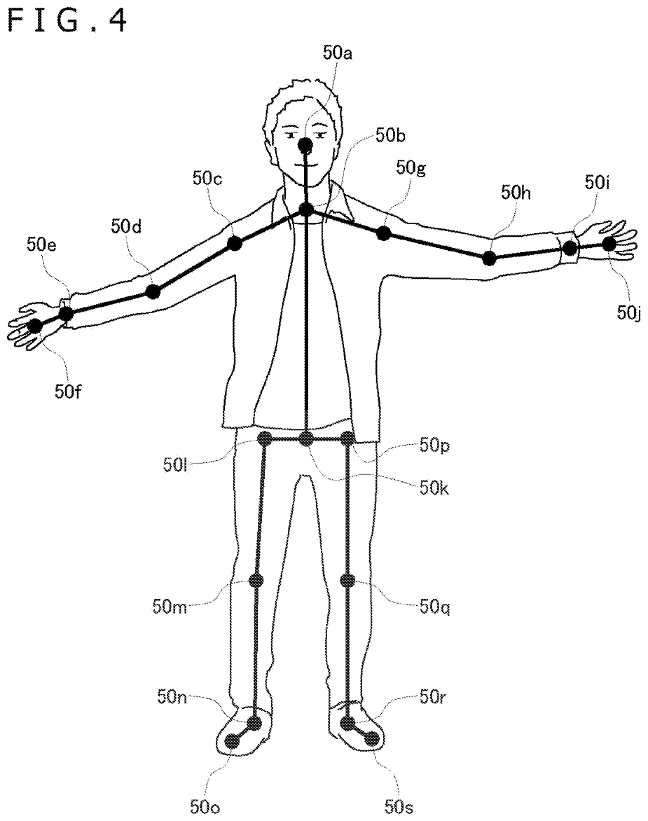

FIG. 4 illustrates a concrete example of the plurality of parts of the performer. In the embodiment, the obtaining section 32 obtains position information of 19 parts of the body of the performer. Specifically, the obtaining section 32 obtains position information of a nose 50a, a neck 50b, a right shoulder 50c, a right elbow 50d, a right wrist 50e, a right hand 50f, a left shoulder 50g, a left elbow 50h, a left wrist 50i, a left hand 50j, a central waist 50k, a right waist 50l, a right knee 50m, a right ankle 50n, a right toe 50o, a left waist 50p, a left knee 50q, a left ankle 50r, and a left toe 50s.

In a human body model adopted in the embodiment, 19 parts are defined, and for each part, parts adjacent to the part are defined. For example, for the neck 50b, the nose 50a, the right shoulder 50c, the left shoulder 50g, and the central waist 50k are defined as adjacent parts, and two adjacent parts are coupled to each other by a bone. For example, for the right elbow 50d, the right shoulder 50c and the right wrist 50e are defined as adjacent parts. Thus, in the human body model, a plurality of parts and coupling relation between two parts are defined. The estimating section 20 estimates the position information of the plurality of parts of the performer on the basis of the human body model.

After the obtaining section 32 obtains the position information of the plurality of parts of the performer, the deriving section 34 derives a length between two parts. The production control section 36 performs production on the basis of the derived length between the two parts.

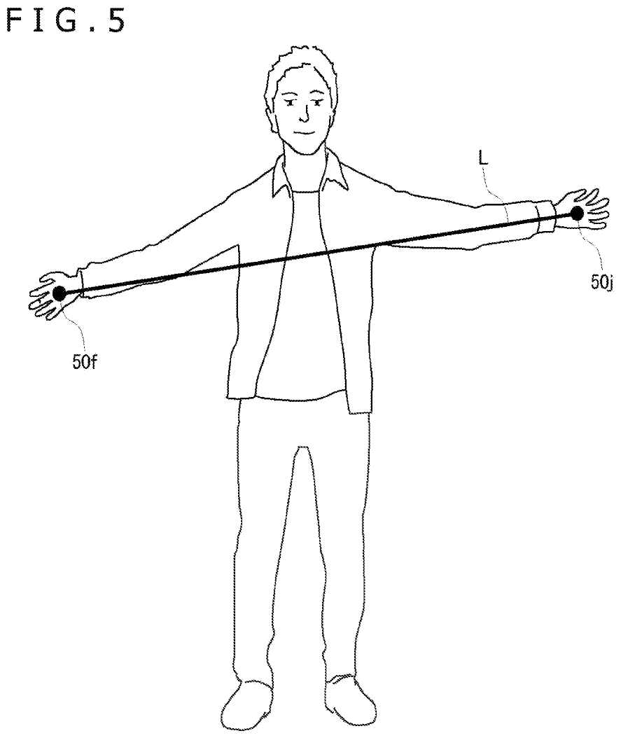

FIG. 5 illustrates an example of the derived length between the two parts. The deriving section 34 derives a length L between the right hand 50f and the left hand 50j. The production control section 36 performs production on the basis of the derived length L. The length L may be derived from a three-dimensional coordinate value of the right hand 50f and a three-dimensional coordinate value of the left hand 50j. It is to be noted that the right hand 50f and the left hand 50j are an example and that the deriving section 34 may derive the length L between two other parts.

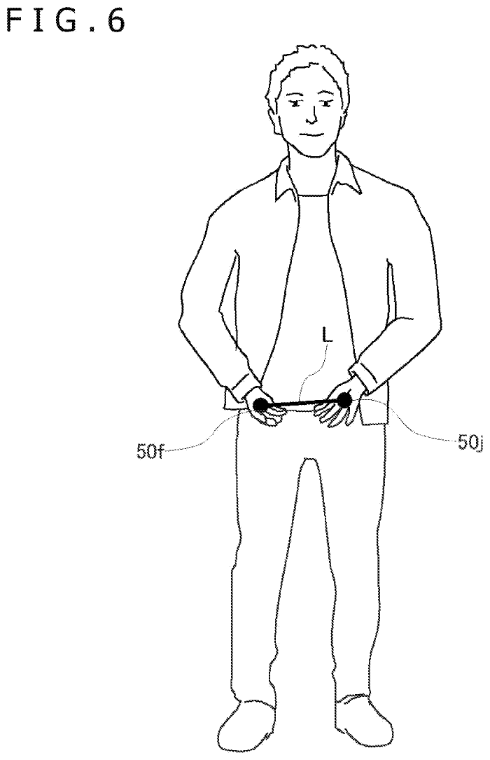

FIG. 6 illustrates another example of the derived length between the two parts. The performer is moving at all times. The length L between the right hand 50f and the left hand 50j therefore changes incessantly.

The production control section 36 may adjust the volume of music output by the sound apparatuses 3 according to the derived length L. For example, the production control section 36 may increase the volume of the music when the length L becomes long, and the production control section 36 may decrease the volume of the music when the length L becomes short. Incidentally, the production control section 36 may decrease the volume of the music when the length L becomes long, and the production control section 36 may increase the volume of the music when the length L becomes short. The production control section 36 may apply a sound effect corresponding to the length L to the music in addition to the volume, and may change the parameter of the sound effect according to the length L. For example, the production control section 36 may amplify and emphasize a high frequency range when the length L becomes long, and the production control section 36 may amplify and emphasize a low frequency range when the length L becomes short.

The production control section 36 may adjust amounts of light of the lighting apparatuses 2 according to the derived length L. For example, the production control section 36 may increase the light amounts when the length L becomes long, and the production control section 36 may decrease the light amounts when the length L becomes short. At this time, the production control section 36 may adjust the light amounts of the lighting apparatuses 2 according to the derived length L while controlling the movable units of the plurality of lighting apparatuses 2 so as to irradiate the right hand 50f or the left hand 50j with light. Incidentally, the production control section 36 may decrease the light amounts when the length L becomes long, and the production control section 36 may increase the light amounts when the length L becomes short. The production control section 36 may adjust the color of the irradiation light in addition to the light amounts, and may change the color of the irradiation light according to the length L.

In the production system 1 according to the embodiment, it is preferable that the deriving section 34 derive a length between two parts not adjacent to each other in the human body model and that the production control section 36 perform production on the basis of the length between the two parts not adjacent to each other. The right hand 50f and the left hand 50j described above are an example of the two parts not adjacent to each other in the human body model. The length L between the two parts not adjacent to each other can be changed greatly as compared with the length between two adjacent parts, and is therefore suitable for use as a dynamic production parameter. For example, the deriving section 34 may derive, as a production parameter, a length between one part of a right half body of a human body and one part of a left half body of the human body. The performer may give performance paying attention to the length between the two parts, for example, give a performance of moving in a left-right direction greatly, by recognizing the two parts set as a production parameter.

In addition, the deriving section 34 may derive, as a production parameter, a length between one part of an upper half of the human body and one part of a lower half of the human body. The performer may give performance paying attention to the length between the two parts, for example, give a performance of moving in an upward-downward direction greatly, by recognizing the two parts set as a production parameter.

Incidentally, the deriving section 34 may derive lengths between a predetermined plurality of sets as a production parameter without being limited to the length between one predetermined set (two specific parts), and the production control section 36 may perform production on the basis of the length between each set. For example, the production control section 36 may perform sound production that controls the sound apparatuses 3 on the basis of a length between parts of a first set, and may perform light production that controls the lighting apparatuses 2 on the basis of a length between parts of a second set different from the first set.

The deriving section 34 may derive a direction connecting two parts to each other as another production parameter. The production control section 36 performs production on the basis of the derived direction.

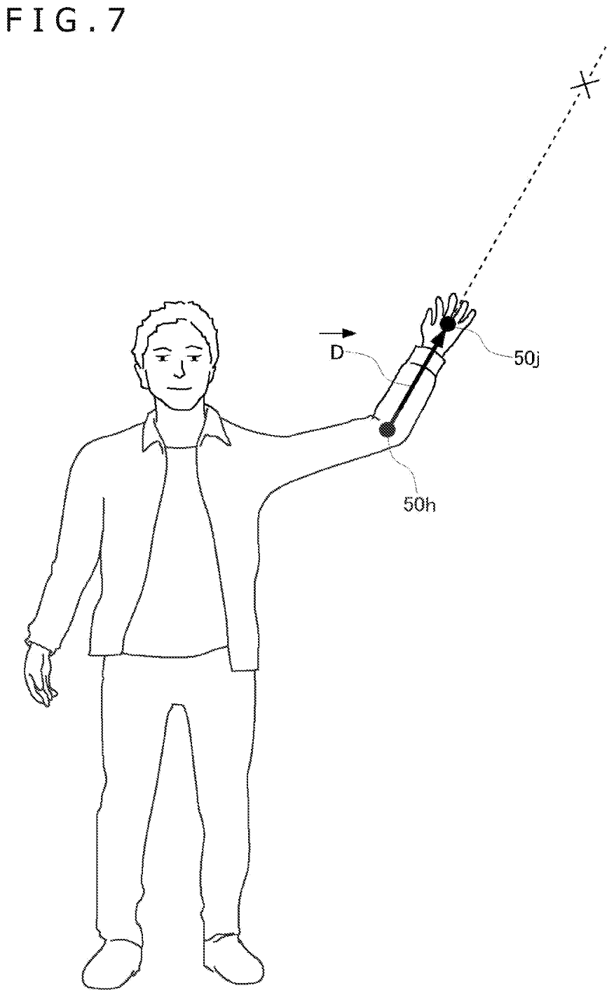

FIG. 7 illustrates an example of the derived direction connecting the two parts to each other. The deriving section 34 derives a direction vector D connecting the left elbow 50h and the left hand 50j to each other. The production control section 36 performs production on the basis of the derived direction vector D. When the deriving section 34 derives the direction vector connecting the two parts to each other, the deriving section 34 may set a more inward part as viewed from a central part in the human body model as a starting point and set a more outward part as an end point, and determine the direction of the direction vector. When the left elbow 50h and the left hand 50j are compared with each other, the left elbow 50h is closer to the central part than the left hand 50j. The production control section 36 therefore derives the direction vector D having the left elbow 50h as a starting point and having the left hand 50j as an end point. Incidentally, the left elbow 50h and the left hand 50j are taken as an example, and the deriving section 34 may derive a direction connecting two other parts to each other.

The production control section 36 may adjust the irradiation directions of light of the lighting apparatuses 2 according to the derived direction vector D. For example, the production control section 36 may control the movable unit of each lighting apparatus 2 such that the plurality of lighting apparatuses 2 apply light to one point (cross mark on a dotted line in FIG. 7) on a half straight line obtained by extending the direction vector D in a direction from the starting point to the end point. The performer can thereby brightly illuminate one point in the direction from the left elbow to the left hand. A distance from the end point of the direction vector D to the one point on the half straight line may be a predetermined distance, or may be set at predetermined times the length of the direction vector. This light production enables the performer to freely manipulate the position irradiated by the lighting apparatuses 2 in the live venue, so that a novel live performance can be realized.

In a case where such light production is performed, it is natural for the performer to specify the position to be irradiated by the lighting apparatuses 2 by moving an arm. It is therefore preferable for the deriving section 34 to derive a direction connecting two parts in a left arm or a right arm to each other and use the direction as a production parameter. However, a direction connecting two parts of other than the arm to each other may be derived.

The present technology has been described above on the basis of the embodiment. According to the embodiment, the production control section 36 can perform production automatically on the basis of a production parameter derived by the deriving section 34. The present embodiment is illustrative, and it is to be understood by those skilled in the art that combinations of constituent elements and processing processes of the embodiment are susceptible of various modifications and that such modifications also fall within the scope of the present technology.

In the embodiment, the photographing target of the camera 4 is a live performer. However, the photographing target may be a person other than the live performer. It is to be noted that the photographing target of the camera 4 may be anything as long as a body model is established and the position information of a plurality of parts can be obtained from a photographed image. The photographing target may, for example, be a human type or pet type autonomous robot.

In the embodiment, description has been made of the camera 4 as a three-dimensional camera capable of obtaining depth information. However, as illustrated in Japanese Patent Laid-Open No. 2020-204890, the camera 4 may be a camera that obtains a two-dimensional image not having depth information.

In the embodiment, the obtaining section 32 derives the length L between two parts as a production parameter. However, for example, a length between one part of the performer and a production apparatus may be derived and used as a production parameter.

In addition, in the embodiment, description has been made of a case where the production system 1 is used in a venue in which the performer performs in front of an audience. However, in a modification, the production system 1 may be used when the performance of the performer is live distribution. In the modification, the production control section 36 may perform video production on the basis of a production parameter derived by the deriving section 34.

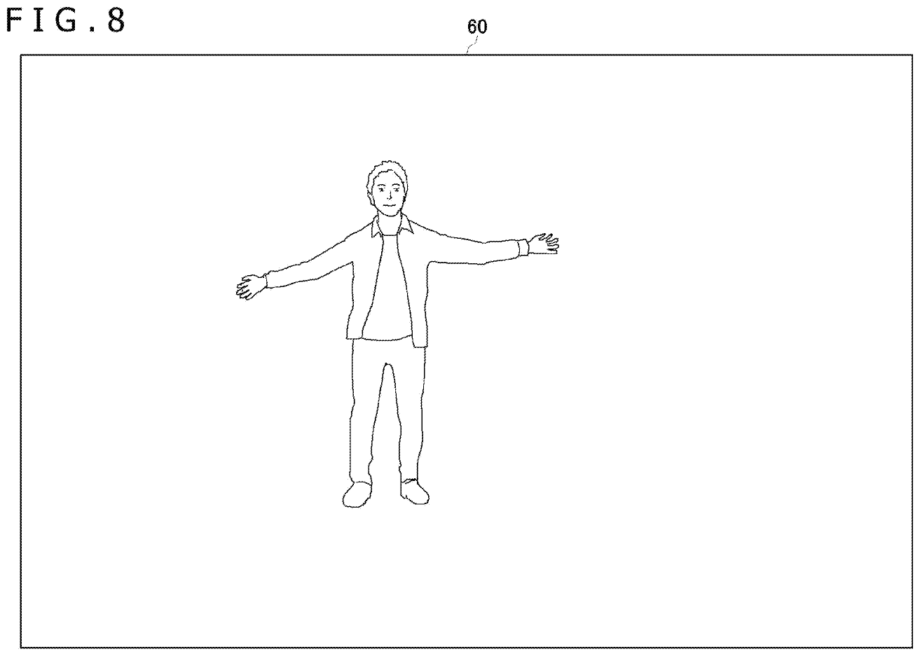

FIG. 8 illustrates an example of video generated by the production control section 36. In the modification, the production control section 36 obtains an image photographed by the camera 4, and generates video 60 for distribution.

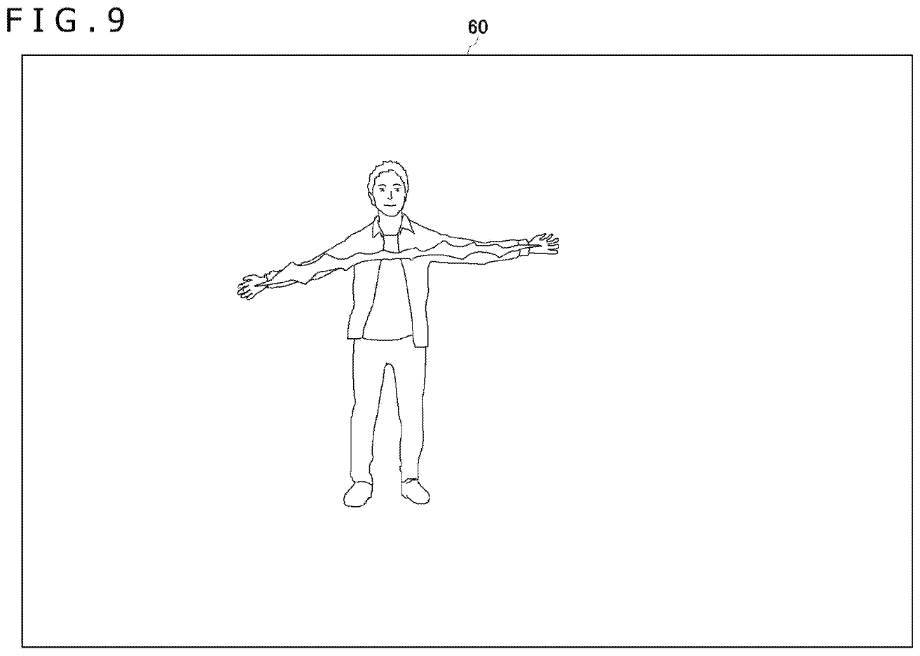

FIG. 9 illustrates an example of video in which the production control section 36 performs video production. In the present example, the production control section 36 performs production (image processing) as if a bolt of lightning streaked between the right hand and the left hand of the performer. The production control section 36 may control the size of the bolt of lightning streaked between the right hand and the left hand of the performer included in the video 60 on the basis of the length L between the right hand 50f and the left hand 50j, which is derived by the deriving section 34.

Incidentally, the production control section 36 may perform video production on the basis of the direction vector D. In the embodiment, the production control section 36 controls the movable units of the respective lighting apparatuses 2 such that the plurality of lighting apparatuses 2 apply light to one point on the half straight line obtained by extending the direction vector D. In the modification, however, the production control section 36 may set a virtual sound source that outputs sound at one point on the half straight line obtained by extending the direction vector D, dispose a light bulb at the position of the virtual sound source, and perform video production such that the virtual sound source moves according to movement of an arm of the performer.

1. An information processing device comprising:
an obtaining section configured to obtain position information of a plurality of parts of a photographing target;
a deriving section configured to derive a length between two parts; and
a production control section configured to perform production on a basis of the derived length.

2. The information processing device according to claim 1, wherein the deriving section derives a length between two parts not adjacent to each other.

3. An information processing device comprising:
an obtaining section configured to obtain position information of a plurality of parts of a photographing target;
a deriving section configured to derive a direction connecting two parts to each other; and
a production control section configured to perform production on a basis of the derived direction.

4. The information processing device according to claim 1, wherein the production control section performs light production and/or sound production.

5. The information processing device according to claim 4, wherein the production control section performs light production and/or sound production by controlling a lighting apparatus and/or a sound apparatus.

6. The information processing device according to claim 1, wherein the production control section performs video production.

7. A non-transitory, computer-readable storage medium containing a program, which when executed by a computer, causes the computer to perform a process, comprising:
obtaining position information of a plurality of parts of a photographing target;
deriving a length between two parts; and
performing production on a basis of the derived length.

8. A non-transitory, computer-readable storage medium containing a program, which when executed by a computer, causes the computer to perform a process, comprising:
obtaining position information of a plurality of parts of a photographing target;
deriving a direction connecting two parts to each other; and
performing production on a basis of the derived direction.
